(19) United States
(12) Patent Application Publication
(10) Pub. No.: US 2004/0194239 A1
(43) Pub. Date: Oct. 7, 2004

(54) Container washing apparatus

(76) Inventor: Ronald Anthony MacDonald, Auckland (NZ)

Correspondence Address: YOUNG & THOMPSON, 745 SOUTH 23RD STREET 2ND FLOOR, ARLINGTON, VA, 22202

(21) Appl. No.: 10/482,202

(22) PCT Filed: Jun. 27, 2002
(86) PCT No.: PCT/NZ02/00117

(30) Foreign Application Priority Data
Jun. 27, 2001 (NZ) 512650

(51) Int. Cl. B08B 1/02

(52) U.S. Cl. 15/88.2; 15/56

(57) ABSTRACT

Washing apparatus for cleaning shipping containers or similar constructions. A rotating sprayer or brush unit is provided along with at least two other sprayer units so as to enable a container to be cleaned on all faces including the twist-lock cavities.

### TECHNICAL FIELD

This invention relates to a container washing apparatus and method of washing a container. The invention is directed particularly but not solely toward washing the outside of shipping containers.

### BACKGROUND ART

The importation of shipping or freight containers has a high probability of introducing diseases and pests through contaminants found in and on container surfaces. The contaminants can be found in many forms including soil, plant material, and animal material. These contaminants pose a very real risk to people, agriculture and indigenous plants and animals. This risk was highlighted by the recent outbreaks of foot and mouth disease (FMD) and mad cow disease, and therefore present very real challenges to the biosecurity of the importing country.

For example, in New Zealand at present container washing is only performed on a percentage inspection rate basis. If a container is found to be dirty or soiled etc then it must be cleaned and or treated. This means that there are many containers that are simply not being checked into New Zealand because of the cost in time and labour. In Australia due to the FMD outbreak in Europe stricter procedures are being implemented. This includes mandatory inspection and cleaning of all imported containers.

### DISCLOSURE OF THE INVENTION

It is the object of the present invention to, provide an improved washing apparatus which will obviate or minimise at least some of the aforementioned problems or which will at least provide the public with a useful choice.

### STATEMENT OF THE INVENTION

Accordingly in one aspect the invention consists in a washing apparatus comprising at least two sprayer units and a rotating sprayer unit.

In another aspect the invention may broadly be said to consists in a washing apparatus comprising at least two brushing units and a rotating brush unit.

Preferably the at least two sprayer units comprise a lower sprayer unit and an upper sprayer unit.

Preferably, the lower sprayer unit includes a shaft having a spraying means.

Preferably, the spraying means is provided by at least one arm.

Preferably the arm is provided on either end of the shaft.

Preferably the arm is an angled member having a nozzle end facing up in use.

Preferably the nozzle can rotate when in use.

Preferably the lower sprayer unit includes at least one roller member.

Preferably the roller member is horizontal in orientation, to support a container in use.

Preferably the roller member comprises a load measuring means.

Preferably, the load measuring means is a load cell.

Preferably, the upper sprayer unit include elongate members.

Preferably, the elongate members have sprayers attached thereto.

Preferably the sprayers comprise tubular members having a nozzle end.

Preferably, the elongate members have at least two nozzles thereon at the upper portion.

Preferably the nozzles can rotate when in use.

Preferably, the elongate members have a biasing means at the lower end.

Preferably, the biasing means is a spring.

Preferably the at least two sprayers at the upper end are separated by a solenoid valve.

Preferably, the elongate member has a pedestal at the ground end.

Preferably, the sprayers have brushes attached thereto.

Alternatively the brushes are separate from the sprayers.

Preferably, the apparatus is provided with a rotating spraying unit.

Preferably, the rotating spraying unit has roller members attached thereto to support a container.

Preferably, the rotating spraying unit has a spraying means.

Preferably, the roller members protrude above from the frame.

Preferably, the roller members are connected by elongate members to form a frame.

Preferably, the frame sits on discrete support members.

Preferably, the spraying means are provided at the end of a rotating elongate member.

Preferably, the elongate member rotates about the center of the length thereof.

Preferably, a fluid is sprayed through the washing apparatus.

Preferably, the fluid can be water.

Preferably, the fluid can be air.

Preferably, heat is sprayed through the washing apparatus.

In a third aspect the invention consists in a method of washing a container utilizing a washing apparatus having a upper sprayer unit, a lower sprayer unit, a rotating sprayer unit and brushes including the steps of:

Locating a container on a lower sprayer unit;

Turning on the lower sprayers to wash at least part of the container;

Turning on upper sprayers to wash at least part of the container;

Moving the container to a rotating spraying unit; and

Turning on a rotating sprayer unit.

Preferably the method includes weighing the container at the lower sprayer unit.

Alternatively the method includes weighing the container at the rotating spraying unit.

Preferably the method includes turning on at least one brush.

Alternatively, the method includes rotating all sprayers.

Alternatively, the method includes applying water through all sprayer units.

Alternatively, the method includes applying heat through all sprayer units.

Alternatively, the method includes applying air through all sprayer units.

Alternatively, the method includes applying water through all brushes

Alternatively, the method includes applying heat through all brushes.

Alternatively, the method includes applying air through all brushes.

In a fourth aspect the invention consists in a method of washing a container utilizing a washing apparatus having an upper brush unit, a lower brush unit, a rotating brush unit and sprayers including the steps of:

Locating a container on a lower brush unit;

Turning on the lower brush unit to clean or wash at least part of the container;

Turning on upper brush unit to clean or wash at least part of the container;

Moving the container to a rotating brushing unit and

Turning on a rotating brush unit.

Preferably the method includes weighing the container at the lower brush unit.

Alternatively the method includes weighing the container at the rotating brush unit.

Alternatively, the method includes rotating all sprayers.

Alternatively, the method includes applying water through all brush units.

Alternatively, the method includes applying heat through all brush units.

Alternatively, the method includes applying air through all brush units.

Alternatively, the method includes applying water through all sprayers.

Alternatively, the method includes applying heat through all sprayer.

Alternatively, the method includes applying air through all sprayers.

### BRIEF DESCRIPTION OF THE DRAWINGS

Preferred forms of the invention will now be described with reference to the accompanying drawings.

FIG. 1 shows a plan view of a first station.

FIG. 2 shows a side view of the first station.

FIG. 3 shows a perspective view of the first station with a construction of FIG. 4.

FIG. 4 shows a perspective view of a second station for use in the working apparatus of a preferred form of the invention, and

FIG. 5 is a side elevation of an alternative embodiment of the construction of FIG. 4,

FIG. 6 is a more detailed plan view of a container washing apparatus according to a preferred form of the invention.

FIG. 7 is a side elevation of FIG. 6 showing a 40 foot container being washed.

FIGS. 8 and 9 are cross sections on A-A and B-B in FIG. 7 respectively, and

FIGS. 10 to 13 are views as for FIGS. 6 to 9 showing the washing of two 20 foot containers.

### DETAILED DESCRIPTION OF THE DRAWINGS

The washing apparatus of the invention is adapted to wash any sort of container, in particular the standard shipping containers which can be the ISO 20 foot or ISO 40 foot containers, the flat track used in the railway situation, high cubes, reefers (i.e. refrigerator containers) and tanks. It is usual to move the containers with cradle lifters or forklifts (not shown) which are common in most freight yards. The dimensions of the washing apparatus will be adapted to allow access with existing containers movers such as the cradle lifters and forklifts. The washing apparatus is made up of a lower and upper sprayer and a rotary unit.

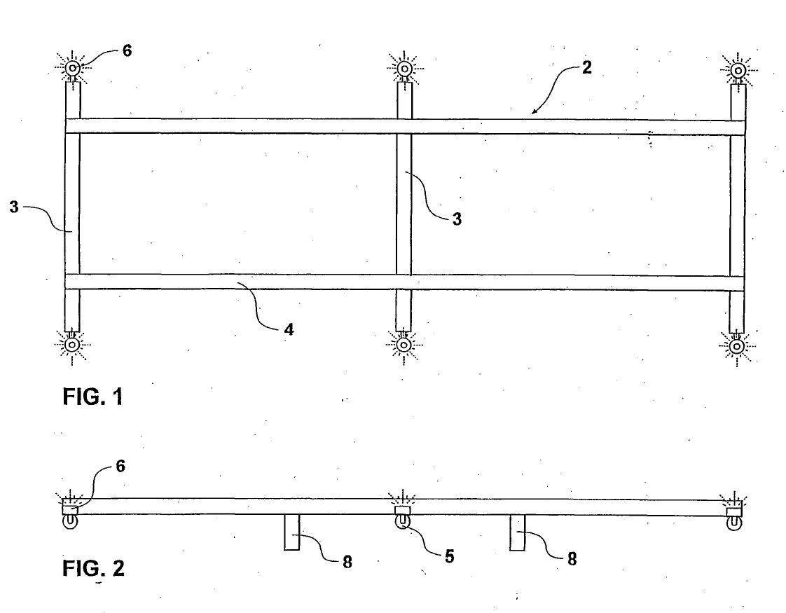

Referring to FIG. 1 this shows the lower sprayer unit having a frame 2 mounting sprayer members. The frame 2 can be made up of frame cross members 3 and frame stringers 4. The frame 2 can be any configuration that is needed to enable the washing apparatus to wash. The frame members 3 and 4 can be of any shape or configuration that is desired. Alternatively, there may be no frame members 4 linking the frame members 3. At least one and preferably all frame members 3 are provided by at least one shaft. Each shaft allows the transport of a fluid which is preferably water. A roller member may be provided with the shaft. The roller member 5 is particularly suitable to assist in ease of movement of a container, in use, and the release of any loading stresses on the rest of the frame. The roller member 5 is made up of a central tubular member through which either the shaft or a hollow portion allows a liquid or water to be fed to and through. At either end or both ends of the shaft or adjacent the roller member, is a nozzle 6 comprising a bent member. The bent member has an end point pointing upwards in use, to clean the lower surface of a container.

FIG. 2 is a side view of the frame 2 of FIG. 1 showing further features. At least one load cell can be used in conjunction with the roller or frame 2 to weigh each container. Preferably more than one load cell is envisaged which would be connected to a measuring device. Also shown in FIG. 2 are a series of pedestals 8 which can be used underneath the frame 2 to support the frame 2 thereof. If the container is raised it is easier to pick up and handle and also to inspect for contaminants.

Alternatively or as an added feature the sprayers may have brushes combined therewith or the brushes may be separately attached. The nozzles for all sprayers may also rotate when required. It is also envisaged that any type fluid may be used—such as water detergents. Air and heat may also be fed through the system as desired.

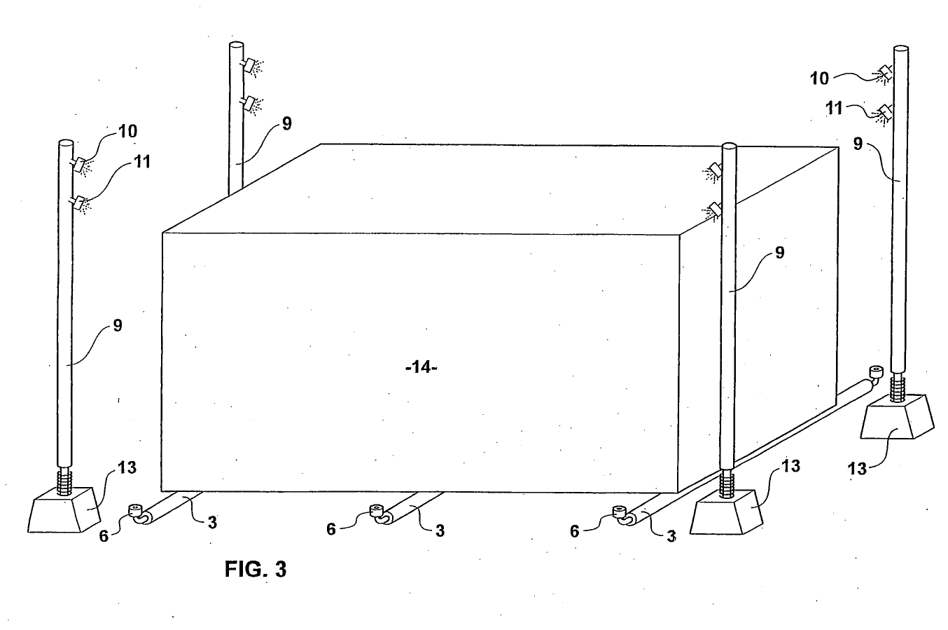

FIG. 3 shows another part of the washing apparatus i.e. the upper sprayer unit. The upper spraying unit is provided with a series of elongate members 9 which can surround the outside of a container 14. It is preferred that the elongate members 9 also sit outside of the lower sprayer unit as shown in FIG. 1. The elongate members 9 comprise an elongate member with a spray means 10 and 11 at one end thereof. The spray means 10 and 11 can be used to spray twist locks at the upper end of the container 14 and also rinse the top of the container. The uprights 9 can also have as an optional feature, a biasing means at the opposite end to the spray means 10 and 11. The biasing means which is preferably a spring, can also be adjacent to a pedestal 13 which is used to support the elongate members 9. The pedestals 13 can be positively fixed in place either using bolting system or even concreted in place. Alternatively the pedestals may sit unfixed on the ground. After the washing or cleaning in station 1 using the elongate members 9 the container is again lifted using a straddle machine (not shown) which lifts and pushes the container along to a station 2.

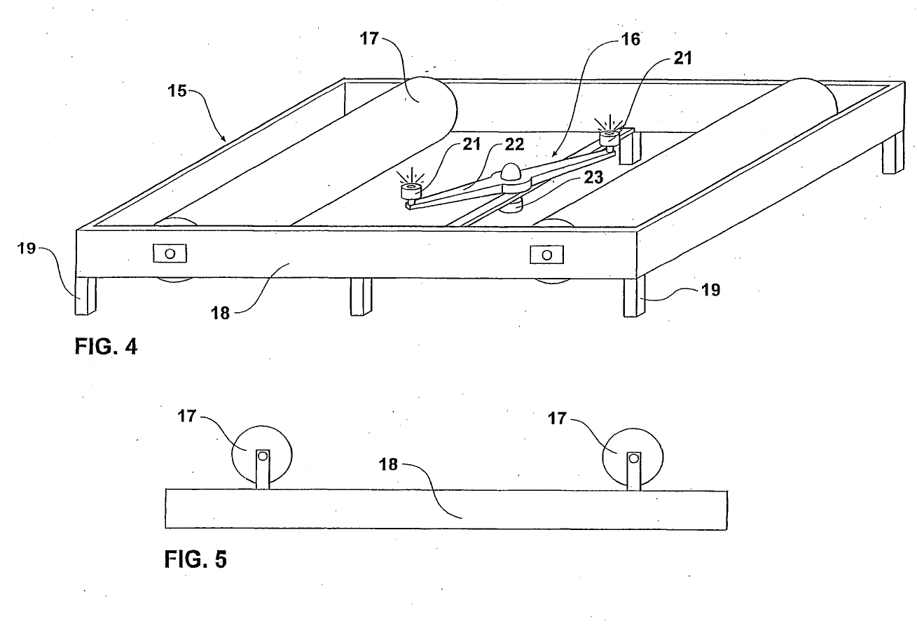

The apparatus shown in FIG. 4 comprises a rotary unit having a support frame 15 and a rotating spray member 16. The support frame 15 can be made up of various cross members 18 and can be in any configuration. The cross members are not essential. It is preferred that frame 15 will at least have roller members 17 at either end to directly support the container 14. As in the first station the rollers 17 are used to reduce any stress through weight on to the frame and the washing or the rotating spray member 16. Instead of rollers one could use a simple non-roller member. Also shown in FIG. 4 are a series of feet 19 which elevate the support frame 15 from the surrounding ground. The rotating member 16 is recessed below the roller members 17 so that it does not get hit by the container. The rotating member 16 has spray members 21 at the respective ends of an elongate member 22 which pivots about a central point 23, which then rotates and sprays to clean the underside of the container. Fluid such as water can be fed to the central point 23.

Alternatively or as an added feature the sprayers may have brushes combined therewith or the brushes may be separately attached. It is also envisaged that any type fluid may be used—such as water detergents. Air and heat may also be fed through the system as desired.

In another alternative as shown in FIG. 5, the roller members 17 can be shown protruding upwards from the support frame 15.

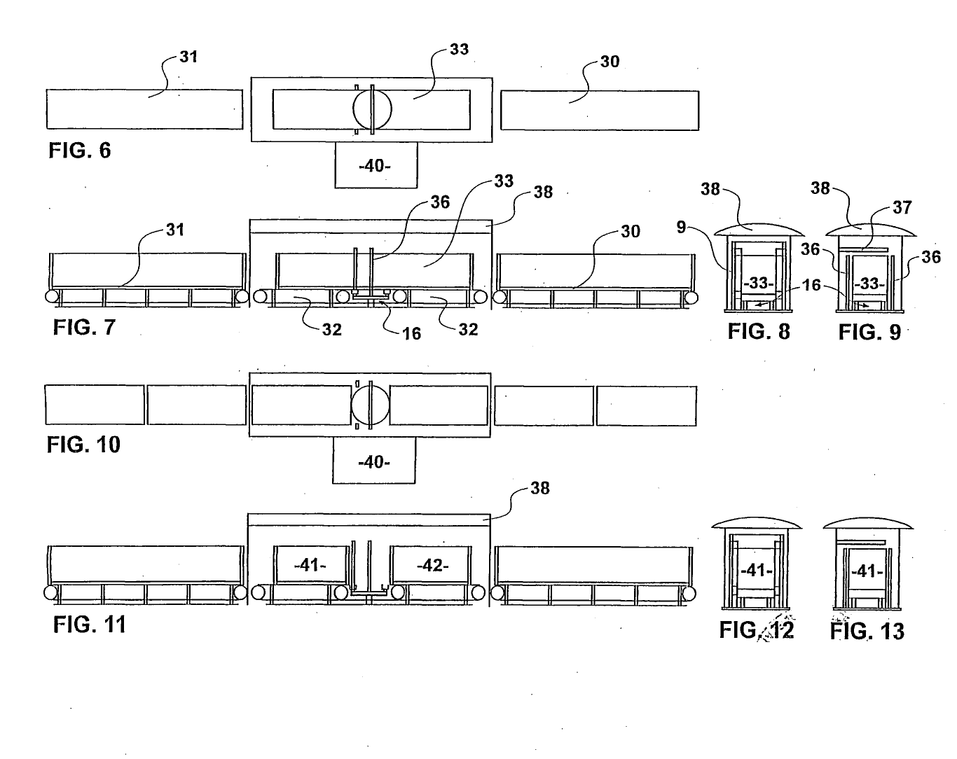

FIGS. 6 to 9 show an infeed conveyor 30 and an outfeed conveyor 31. Intermediate conveyors 32 carrying a 40 foot container 33. The rotary underneath washer 16 is provided adjacent uprights 36 with spray apertures or nozzles to spray the container sides. An overhead spray device 37 is provided. A canopy 38 can be provided as well as sides, such as transparent PVC material and ends which may be of a strip curtain construction. A control room 40 can be provided.

FIGS. 10 to 13 are similar save that two 20 foot containers 41 and 42 are washed. Although two stations are described clearly these can be at substantially the same position as seen in FIGS. 6 to 13.

To operate, the washing apparatus one merely has to lift the container into place on to the lower spraying unit, set the spray means going which automatically using timers will spray and wash the top of the container and all twist locks. Alternatively the lower sprayer can be operated separately to the upper spraying unit. Following this washing by the lower and upper sprayers the container is moved to the rotary unit where the underneath of the container is thoroughly washed using a high pressure rotating spray member 16. This process is preferably automatic and timed so that all containers are cleaned to approved and preprogrammed guidelines. Alternatively, any part of the washing apparatus or the whole apparatus or any combination thereof can be manually operated. If the process is interrupted a warning light can alert the operator and the container can be put back through the system again. Another alternative is envisaged that the washing apparatus could be sold to any operator to install and or use themselves. In yet another option the container could be automatically moved through the two stations without having to manually lift the container from station to station using a straddle machine or fork lift.

Variations

This invention may broadly be said to consist in the parts, elements and features referred to or indicated in the specification of the application individually or collectively in any and all combinations of any two or more of the parts, elements or features and where specific integers are mentioned herein which have known equivalents such equivalents are deemed to be incorporated herein as if individually set forth.

Advantages

The washing apparatus has the following advantages:

fast complete cleaning/washing method

reduces disease, plant and animal risks

mechanised method

eliminates human error

all containers can be cleaned

can set up washing facility anywhere

reduces inspection time required

eliminates expensive quarantine charges and delays

reduces costs to importers, port authorities and shipping authorities

excellent marketing angle for promoting exports/imports

Thus it can be seen that the washing apparatus in the preferred form conveniently washes a container both thoroughly and quickly while meeting stringent health and safety requirements.

1. A washing apparatus comprising at least two sprayer units and a rotating sprayer unit.

2. A washing apparatus comprising at least two brushing units and a rotating brush unit.

3. A washing apparatus as claimed in claim 2, wherein the at least two sprayer units comprise a lower sprayer unit and an upper sprayer unit.

4. A washing apparatus as claimed in claim 3, wherein the lower sprayer unit includes a shaft having a spraying means.

5. A washing apparatus as claimed in claim 4, wherein the spraying means is provided by at least one arm.

6. A washing apparatus as claimed in claim 5, wherein the arm is provided on either end of the shaft.

7. A washing apparatus as claimed in claim 5, wherein the arm is an angled member having a nozzle end facing up in use.

8. A washing apparatus as claimed in claim 7, wherein the nozzle can rotate when in use.

9. A washing apparatus as claimed in claim 3, wherein the lower sprayer unit includes at least one roller member.

10. A washing apparatus as claimed in claim 9, wherein the roller member is horizontal in orientation, to support a container in use.

11. A washing apparatus as claimed in claim 9, wherein the roller member comprises a load measuring means.

12. A washing apparatus as claimed in claim 11, wherein the load measuring means is a load cell.

13. A washing apparatus as claimed in claim 3, wherein the upper sprayer unit includes elongate members.

14. A washing apparatus as claimed in claim 13, wherein the elongate members have sprayers attached thereto.

15. A washing apparatus as claimed in claim 14, wherein the sprayers comprise tubular members having a nozzle end.

16. A washing apparatus as claimed in claim 13, wherein the elongate members have at least two nozzles thereon at the upper portion.

17. A washing apparatus as claimed in claim 16, wherein the nozzles can rotate when in use.

18. A washing apparatus as claimed in claim 13, wherein the elongate members have a biasing means at the lower end.

19. A washing apparatus as claimed in claim 18, wherein the biasing means is a spring.

20. A washing apparatus as claimed in claim 15, wherein at least two sprayers are provided at the upper end the sprayers being separated by a solenoid valve.

21. A washing apparatus as claimed in claim 14, wherein the elongate member has a pedestal at the ground end.

22. A washing apparatus as claimed in claim 14, wherein the sprayers have brushes attached thereto.

23. A washing apparatus as claimed in claim 14, further including brushes.

24. A washing apparatus as claimed in claim 2, further including a rotating spraying unit.

25. A washing apparatus as claimed in claim 24, wherein the rotating spraying unit has roller members attached thereto to support a container.

26. A washing apparatus as claimed in claim 25, wherein the rotating spraying unit has a spraying means.

27. A washing apparatus as claimed in claim 25, wherein the roller members protrude above from the frame.

28. A washing apparatus as claimed in claim 27, wherein the roller members are connected by elongate members to form a frame.

29. A washing apparatus as claimed in claim 28, wherein the frame sits on discrete support members.

30. A washing apparatus as claimed in claim 26, wherein the spraying means are provided at the end of a rotating elongate member.

31. A washing apparatus as claimed in claim 30, wherein the elongate member rotates about the center of the length thereof.

32. A washing apparatus as claimed in claim 2, wherein a fluid is sprayed through the washing apparatus.

33. A washing apparatus as claimed in claim 32, wherein the fluid is water.

34. A washing apparatus as claimed in claim 32, wherein the fluid is air.

35. A washing apparatus as claimed in claim 32, wherein the fluid sprayed through the washing apparatus is heated.

36. A method of washing a container utilizing a washing apparatus having a upper sprayer unit, a lower sprayer unit, a rotating sprayer unit and brushes including the steps of:
Locating a container on a lower sprayer unit;
Turning on the lower sprayers to wash at least part of the container;
Turning on upper sprayers to wash at least part of the container;
Moving the container to a rotating spraying unit; and
Turning on a rotating sprayer unit.

37. A method as claimed in claim 36, wherein the method includes weighing the container at the lower sprayer unit.

38. A method as claimed in claim 36, wherein the method includes weighing the container at the rotating spraying unit.

39. A method as claimed in claim 36 further including turning on at least one brush.

40. A method as claimed in claim 36, wherein the method includes the step of rotating all sprayers.

41. A method as claimed in claim 36, wherein the method includes applying water or air through all sprayer units.

42. A method as claimed in claim 41, wherein the method includes applying heat or water or air through all sprayer units.

43. A method as claimed in claim 36, wherein the method includes applying water or air through all brushes.

44. A method as claimed in claim 36, wherein the method includes applying heat through all brushes.

45. A method of washing a container utilizing a washing apparatus having an upper brush unit, a lower brush unit, a rotating brush unit and sprayers including the steps of:
Locating a container on a lower brush unit;
Turning on the lower brush unit to clean or wash at least part of the container;
Turning on upper brush unit to clean or wash at least part of the container;
Moving the container to a rotating brushing unit and
Turning on a rotating brush unit.

46. A method as claimed in claim 45, wherein the method includes weighing the container at the lower brush unit.

47. A method as claimed in claim 45, wherein the method includes weighing the container at the rotating brush unit.

48. A method as claimed in claim 45, wherein the method includes rotating all sprayers.

49. A method as claimed in claim 45, wherein the method includes applying water through all brush units.

50. A method as claimed in claim 45, wherein the method includes applying heat through all brush units.

51. A method as claimed in claim 45, wherein the method includes applying water or air through all sprayers.

52. A method as claimed in claim 45, wherein the method includes applying heat through all sprayer.
